(19) United States
(12) Patent Application Publication
(10) Pub. No.: US 2026/0251571 A1
(43) Pub. Date: Aug. 27, 2026

(54) METHOD AND DEVICE FOR ANALYZING SAMPLES

(71) Applicant: Electronics and Telecommunications Research Institute, Daejeon (KR)

(72) Inventors: Hyowoong NOH, Daegu (KR); Dae-Sik LEE, Daejeon (KR); Junyeong LEE, Daejeon (KR); Byeongju LEE, Daejeon (KR)

(73) Assignee: Electronics and Telecommunications Research Institute, Daejeon (KR)

(21) Appl. No.: 19/357,326

(22) Filed: Oct. 14, 2025

(30) Foreign Application Priority Data
Feb. 24, 2025 (KR) 10-2025-0023866

(51) Int. Cl. G01N 21/64

(52) U.S. Cl. CPC G01N 21/6428; G01N 21/645; G01N 2021/6439; G01N 2021/6471; G01N 2201/0231; G01N 2201/06106

(57) ABSTRACT

A sample analysis device is provided. The sample analysis device includes a sample tray on which a sample is placed, a measurement unit configured to measure the sample based on light emitted from the sample or transmitted through the sample, and a processing unit configured to analyze the sample based on the light. The measurement unit includes a first light source configured to emit first light, a second light source configured to emit second light, and a sensor configured to sense third light and fourth light, wherein the third light is fluorescence emitted after being excited by the first light incident on the sample, and wherein the fourth light is generated by the second light being transmitted through the sample. The light includes the third light and the fourth light obtained from the sensor.

### CROSS-REFERENCE TO RELATED APPLICATION

This application claims priority from Korean Patent Application No. 10-2025-0023866, filed on February 24, 2025, in the Korean Intellectual Property Office, the entire disclosure of which is incorporated herein by reference for all purposes.

### BACKGROUND

### Field

Methods and apparatuses consistent with embodiments relate to a method and device for analyzing samples.

### Description of the Related Art

Currently, infectious diseases such as coronavirus disease 2019 (COVID-19) are generally diagnosed using polymerase chain reaction (PCR) technology, which amplifies a nucleic acid of a target pathogen and optically measures the nucleic acid. While the PCR technology offers high detection sensitivity for target pathogens, it also has limitations in that it requires a specialist, expertise, and a bulky thermocycler and that it is lengthy and complex. In particular, when using clinical samples such as blood, the specificity may be low, potentially leading to false positive diagnoses.

Loop-mediated isothermal amplification (LAMP) is one of nucleic acid amplification technologies. Unlike PCR, which requires repetition of a thermocycling process, LAMP technology is one of representative isothermal amplification technologies, in which all amplification processes may be performed at a fixed temperature of approximately 65°C. LAMP technology has advantages of not requiring expensive equipment, being faster (~30 minutes) than PCR, being simpler, and having high specificity.

The above description has been possessed or acquired by the inventor(s) in the course of conceiving the present disclosure and is not necessarily an art publicly known before the present application is filed.

### SUMMARY

Embodiments provide technology for performing a qualitative analysis and a quantitative analysis of samples simultaneously.

Embodiments provide technology for determining whether a target pathogen is included in a sample by analyzing an optical property of the sample.

However, the technical aspects are not limited to the aforementioned aspects, and other technical aspects may be present.

One or more embodiments may address at least the above problems and/or disadvantages and other disadvantages not described above. Also, the embodiments are not required to overcome the disadvantages described above, and an embodiment may not overcome any of the problems described above.

According to an aspect of an embodiment, there is provided a sample analysis device including a sample tray on which a sample is placed, a measurement unit configured to measure the sample based on light emitted from the sample or transmitted through the sample, and a processing unit configured to analyze the sample based on the light. The measurement unit includes a first light source configured to emit first light, a second light source configured to emit second light, and a sensor configured to sense third light and fourth light, wherein the third light is fluorescence emitted after being excited by the first light incident on the sample, and wherein the fourth light is generated by the second light being transmitted through the sample. The light includes the third light and the fourth light obtained from the sensor.

The measurement unit may further include a mirror disposed in a path of the first light to reflect the first light and irradiate the first light to the sample.

The mirror may be a dichroic mirror that reflects light of a specific wavelength.

The processing unit may be configured to analyze the sample based on a disparity between the second light and the fourth light, and the third light.

The sample analysis device may further include a temperature control unit configured to control a temperature of the sample tray.

The first light source and the second light source may be configured to simultaneously emit the first light and the second light, respectively.

The second light source may be a multi-wavelength light source, and the second light may have a uniform intensity of light in each wavelength range.

The sample analysis device may further include a display configured to display a result of analyzing the sample, obtained from the processing unit.

According to an aspect of an embodiment, there is provided a method of analyzing a sample, performed by a sample analysis device. The method includes emitting each of first light and second light. The method includes sensing third light and fourth light, wherein the third light is fluorescence emitted after being excited by the first light incident on the sample placed on a sample tray, and wherein the fourth light is generated by the second light being transmitted through the sample. The method includes analyzing the sample based on the third light and the fourth light.

The emitting of each of the first light and the second light may include emitting the first light using a first light source. The emitting of each of the first light and the second light may include emitting the second light using a second light source.

The analyzing of the sample may include analyzing the sample based on a disparity between the second light and the fourth light, and the third light.

The first light source and the second light source may be configured to simultaneously emit the first light and the second light, respectively.

The second light source may be a multi-wavelength light source, and the second light may have a uniform intensity of light in each wavelength range.

The sensing of the third light and the fourth light may include irradiating the first light, which may be reflected by a mirror disposed in a path of the first light, to the sample.

The mirror may be a dichroic mirror that reflects light of a specific wavelength.

The method may further include displaying a result of analyzing the sample.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a diagram schematically illustrating a sample analysis device according to an embodiment;

FIG. 2 is a diagram schematically illustrating a measurement unit illustrated in FIG. 1;

FIG. 3 is a diagram illustrating an operation of sensing a fluorescent signal included in a sample;

FIG. 4 is a diagram illustrating an operation of sensing a change in color of a sample;

FIG. 5 is a flowchart illustrating an operation of sensing a fluorescent signal included in a sample;

FIG. 6 is a flowchart illustrating an operation of sensing a change in color of a sample; and

FIG. 7 is a flowchart illustrating an operation of sensing a fluorescent signal included in a sample or a change in color of the sample.

### DETAILED DESCRIPTION

The following detailed structural or functional description is provided as an example only and various alterations and modifications may be made to the embodiments. Thus, an actual form of implementation is not construed as limited to the embodiments described herein and should be understood to include all changes, equivalents, and replacements within the idea and the technical scope of the disclosure.

Although terms such as first, second, and the like may be used herein to describe various components, the components are not limited to the terms. These terms should be used only to distinguish one component from another component. For example, a first component may be referred to as a second component, and similarly, the second component may be referred to as the first component.

It should be noted that if one component is described as being "connected," "coupled," or "joined" to another component, the first component may be directly connected, coupled, or joined to the second component, or a third component may be "connected," "coupled," or "joined" between the first and second components.

The singular forms "a," "an," and "the" used herein are intended to include the plural forms as well, unless the context clearly indicates otherwise. As used herein, each of phrases such as "A or B," "at least one of A and B," "at least one of A or B," "A, B, or C," "at least one of A, B, and C," and "at least one of A, B, or C" may include any one of the items listed in the corresponding one of the phrases or all possible combinations thereof. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

The term "unit" or the like used herein may refer to a software or hardware component, such as a field-programmable gate array (FPGA) or an application-specific integrated circuit (ASIC), and the "unit" performs predefined functions. However, the "unit" is not limited to software or hardware. The "unit" may be configured to reside on an addressable storage medium or configured to operate one or more processors. For example, the "unit" may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and "units" may be combined into fewer components and "units" or may be further separated into additional components and "units." Furthermore, the components and "units" may be implemented to operate on one or more central processing units (CPUs) within a device or a security multimedia card. In addition, the "unit" may include one or more processors.

Hereinafter, the embodiments are described in detail with reference to the accompanying drawings. When describing the embodiments with reference to the accompanying drawings, like reference numerals refer to like components and a repeated description related thereto is omitted.

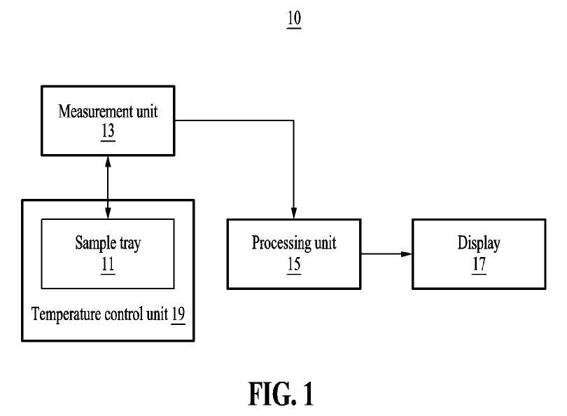

FIG. 1 is a diagram schematically illustrating a sample analysis device according to an embodiment.

Referring to FIG. 1, a sample analysis device 10 may be a compact device for analyzing an optical property of a nucleic acid amplification sample for a target pathogen in real time. The sample analysis device 10 may accurately and quickly diagnose an onset of a target disease at a clinical site in a non-invasive manner. The sample analysis device 10 may increase an early detection rate of an infectious disease and reduce an incidence rate.

The sample analysis device 10 may include a sample tray 11 and/or a measurement unit 13. The sample analysis device 10 may further include a processing unit 15. The sample analysis device 10 may further include a display 17. The sample analysis device 10 may further include a temperature control unit 19.

The sample tray 11 may secure a sample container in a same position. The sample container containing a sample may be placed on the sample tray 11.

The measurement unit 13 may measure the sample based on light emitted from or transmitted through the sample. The measurement unit 13 may sense (or obtain) the light emitted from or transmitted through the sample. The measurement unit 13 may transfer (or transmit) the sensed (or obtained) light to the processing unit 15.

The processing unit 15 may analyze the sample based on the light transferred from the measurement unit 13. For example, the processing unit 15 may determine whether there is a nucleic acid in a target pathogen in the sample. In another example, the processing unit 15 may determine whether to proceed with amplification based on the light. In still another example, a nucleic acid amplification process may be an example of a qualitative analysis. The processing unit 15 may evaluate a degree of nucleic acid amplification in real time based on the light. An operation of evaluating the degree of nucleic acid amplification in real time may be an example of a quantitative analysis.

The processing unit 15 may include a signal conversion module, a signal preprocessing module, a processor, and/or a communication module. The signal conversion module may obtain a discrete analog signal, which may be obtained by dividing light, an analog signal, through a sampling circuit every predetermined cycle. The signal conversion module may minimize a data loss of the light through the sampling circuit. The signal conversion module may convert the discrete analog value into a digital signal through an analog-to-digital converter (ADC), based on a discrete analog value. The signal conversion module may electrically communicate with the measurement unit 13, which may transmit the light, and may receive the light in synchronization with a light output time of the measurement unit 13.

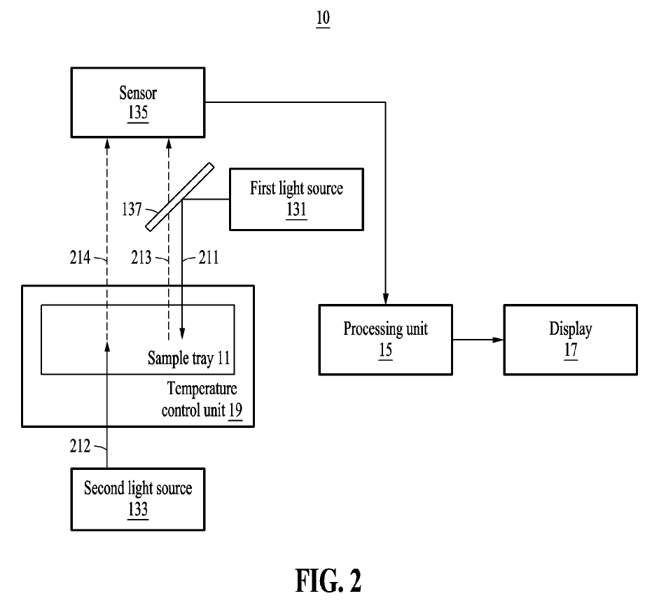

The signal preprocessing module may be configured to remove noise from the converted digital signal and process the converted digital signal into an analyzable form. The signal preprocessing module may, based on the converted digital signal, remove noise from the converted digital signal through a noise filter. The signal preprocessing module may improve the reliability of a digital signal analysis through the noise filter. The signal preprocessing module may process the noise-removed digital signal through a multi-signal synchronization circuit to simultaneously process different types of signals (e.g., a first signal generated based on a disparity between the second light 212 and the fourth light 214 of FIG. 2 and a second signal based on the third light 213 of FIG. 2). For example, the signal preprocessing module may synchronize the first signal, which may be generated based on a disparity between the second light 212 and the fourth light 214, with the second signal, which may be based on the third light 213 of FIG. 2, for analysis. The first signal may be a signal obtained by preprocessing (e.g., conversion through an ADC, noise removal, division through a sampling circuit, and signal normalization) the disparity between the second light 212 and the fourth light 214. The second signal may be a signal obtained by preprocessing (e.g., conversion through an ADC, noise removal, division through a sampling circuit, and signal normalization) the third light 213.

The processor included in the processing unit 15 may obtain a result of analyzing the sample based on whether a signal (e.g., the first signal and the second signal) generated based on the light obtained from the measurement unit 13 exceeds a set value (e.g., a preset threshold). The result of analyzing the sample obtained by the processor may include a presence or absence of a pathogen and/or a concentration of the pathogen.

The communication module included in the processing unit 15 may transfer (or transmit) the result of analyzing the sample to an external device (e.g., the display 17) that is directly or electrically connected. The communication module may communicate with a smartphone or a tablet via Bluetooth and perform functions for managing a network with the external device connected to the processing unit 15. For example, the communication module may perform functions such as encryption of network traffic, recovery from a network failure, and/or reconnection to the network.

The processing unit 15 may be implemented within the sample analysis device 10 or may be implemented outside the sample analysis device 10 as a separate device from the sample analysis device 10. For example, the processing unit 15 may be implemented as a separate hardware device from the sample analysis device 10. The processing unit 15 may process data stored in memory (not shown). The processing unit 15 may execute computer-readable code (for example, software) stored in the memory (not shown) and instructions triggered by the processing unit 15. The processing unit 15 may be a hardware-implemented device having a circuit that is physically structured to execute desired operations.

The display 17 may obtain (or receive) the result of analyzing the sample from the processing unit 15. The display 17 may display the result of analyzing the sample, obtained from the processing unit 15.

The temperature control unit 19 may control a temperature of the sample tray 11. The temperature control unit 19 may set and maintain the temperature of the sample tray 11. The temperature control unit 19 may control the temperature of the sample tray 11 using a heater connected or attached to the sample tray 11 for applying heat to the sample tray 11, a temperature sensor for sensing current temperature, and/or a cooling device for reducing the temperature. For example, the temperature control unit 19 may adjust a set temperature and/or a temperature holding time of the sample tray 11 based on a type of target pathogen and/or characteristics of the sample. The temperature control unit 19 may be a component for adjusting the temperature of the sample tray 11 and does not necessarily need to be implemented (or arranged) in a form of surrounding or including the sample tray 11. The temperature control unit 19 may be arranged at a position physically separated from the sample tray 11 or be in contact with a predetermined part of the sample tray 11 to control the temperature and may also control the temperature of the sample tray 11 in a non-contact manner when necessary. The specific arrangement of the temperature control unit 19 may vary depending on the specific implementation form.

FIG. 2 is a diagram schematically illustrating a measurement unit illustrated in FIG. 1.

Referring to FIG. 2, a measurement unit (e.g., the measurement unit 13 of FIG. 1) may include a first light source 131, a second light source 133, and/or a sensor 135. The measurement unit 13 may further include a mirror 137.

The first light source 131 may emit first light 211. The first light 211 may be light to excite a fluorescent dye contained in a sample in the sample tray 11. The first light source 131 may be positioned above the sample tray 11. The first light source 131 may be a multi-wavelength light source. The multi-wavelength light source may emit light in one or more wavelength ranges individually or simultaneously. The first light source 131 may adjust (or select) a wavelength and/or a width of a wavelength range of the first light 211. A user (not shown) may adjust (or select) the wavelength and/or the width of the wavelength range of the first light 211, which the first light source 131 emits, to correspond to characteristics of the sample.

The second light source 133 may emit second light 212. The second light source 133 may be a multi-wavelength light source. The second light 212 may have a uniform intensity of light in each wavelength range. The width of the wavelength range of the first light 211 may be narrower than a width of each wavelength range of the second light 212.

The sensor 135 may obtain (or sense) third light 213 emitted after being excited by the first light 211 incident on the sample. The third light 213 may be fluorescence. A wavelength and/or a wavelength range of the third light 213 may be determined based on a fluorescent material contained in the sample. The sensor 135 may obtain (or sense) fourth light 214 generated by the second light 212 being transmitted through the sample.

The mirror 137 may reflect the first light 211 and irradiate the first light 211 to the sample. The mirror 137 may be disposed in a path of the first light 211 to reflect the first light 211 and irradiate the first light 211 to the sample. The mirror 137 may be a dichroic mirror that reflects light of a specific wavelength. The mirror 137 may pass the third light 213 and/or the fourth light 214 through.

The sample analysis device 10 may include at least one sample tray 11. The sample analysis device 10 may move the measurement unit 13 to analyze the sample in the at least one sample tray 11. The sample analysis device 10 may further include a motor to move the measurement unit 13. The sample analysis device 10 may move the measurement unit 13 to analyze a sample in a sample tray other than the sample tray 11. The sample analysis device 10 may further include a circuit to control the motor configured to move the measurement unit 13.

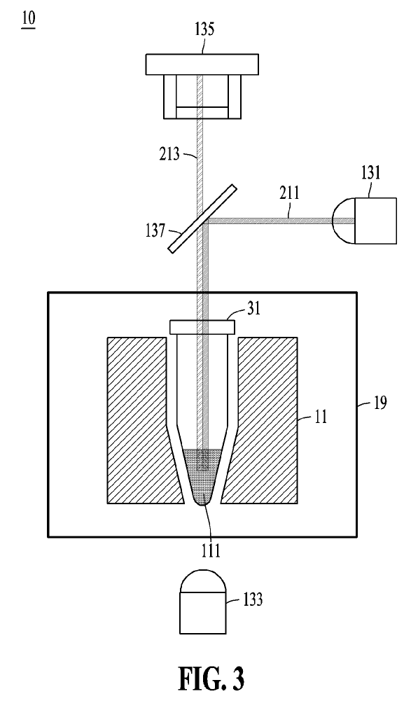

FIG. 3 is a diagram illustrating an operation of sensing a fluorescent signal included in a sample.

Referring to FIG. 3, the first light source 131 may emit the first light 211. The sample analysis device 10 may stop an operation of the second light source 133 when the first light source 131 emits the first light 211. The first light 211 may be reflected by the mirror 137. The sample analysis device 10 may irradiate the first light 211 reflected by the mirror 137 to a sample 111 contained in a sample container 31 included in the sample tray 11. The first light 211 reflected by the mirror 137 may be irradiated to the sample 111 contained in the sample container 31 included in the sample tray 11. The mirror 137 may reflect light in a wavelength range, among the wavelength range of the first light 211, for exciting a fluorescent dye contained in the sample 111 and may transmit light with a wavelength greater than the wavelength range for exciting a fluorescent dye.

The sample container 31 may be a commercial polymerase chain reaction (PCR) tube or a microfluidic chip designed for nucleic acid amplification but is not limited thereto. The sample container 31 may have a portion thereof open for light (e.g., a light signal) to transmit through or may be made of a material through which light may pass.

The sensor 135 may obtain (or sense) the third light 213 emitted after being excited by the first light 211 incident on the sample 111. The sensor 135 may be positioned above the sample tray 11. The mirror 137 may be disposed not to be positioned in a path of the third light 213, which may be from the sample 111 to the sensor 135. The mirror 137 may be disposed between the sensor 135 and the sample container 31. The sensor 135 may obtain fluorescence (e.g., a fluorescence signal) of one or more wavelength ranges. The sensor 135 may be a high-sensitivity sensor capable of obtaining light individually or simultaneously by distinguishing the light by wavelength. The sensor 135 may use a wavelength filter that passes only light of a specific wavelength range through.

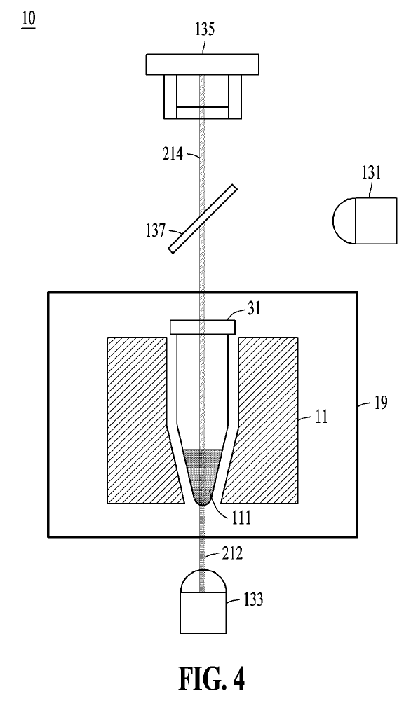

FIG. 4 is a diagram illustrating an operation of sensing a change in color of a sample.

Referring to FIG. 4, the second light source 133 may emit the second light 212. The second light source 133 may be disposed below the sample tray 11. The sample analysis device 10 may stop an operation of the first light source 131 when the second light source 133 emits the second light 212. The sample analysis device 10 may allow the first light source 131 and the second light source 133 to simultaneously emit the first light 211 and the second light 212, respectively. The second light source 133 may irradiate the second light 212 to the sample 111. The second light 212 may be irradiated to the sample 111.

The sensor 135 may obtain (or sense) the fourth light 214 generated by the second light 212 being projected onto the sample 111. The fourth light 214 may not be reflected by the mirror 137. The mirror 137 may not be disposed not to be positioned in a path of the fourth light 214, which may be from the sample 111 to the sensor 135. The sensor 135 may be a sensor that obtains (or senses) each of third light (e.g., the third light 213 of FIG. 3) and the fourth light 214.

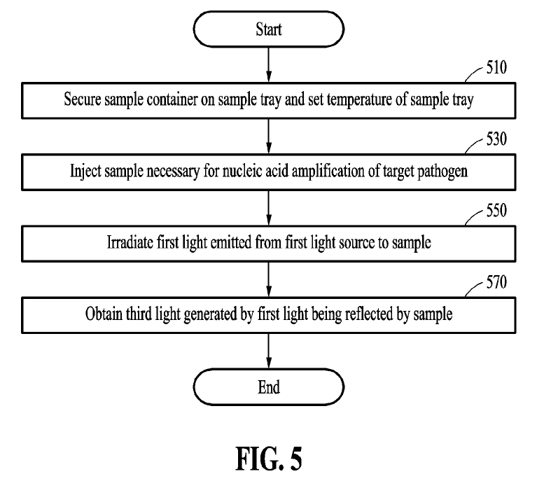

FIG. 5 is a flowchart illustrating an operation of sensing a fluorescent signal included in a sample.

Referring to FIG. 5, operations 510 to 570 may be operations performed by a sample analysis device (e.g., the sample analysis device 10 of FIG. 1) described with reference to FIGS. 1 to 7.

In operation 510, the sample analysis device 10 may position and secure a sample container (e.g., the sample container 31 of FIG. 3) on a sample tray (e.g., the sample tray 11 of FIG. 1). The sample analysis device 10 may set a temperature of the sample tray 11 suitable for nucleic acid amplification of a target pathogen in the sample tray 11 through a temperature control unit (e.g., the temperature control unit 19 of FIG. 1).

In operation 530, the sample analysis device 10 may mix a nucleic acid of the target pathogen extracted from the sample (e.g., the sample 111 of FIG. 3) with materials necessary for the nucleic acid amplification. The sample analysis device 10 may inject mixed materials into the sample container 31. The materials necessary for the nucleic acid amplification may include a deoxyribonucleic acid (DNA) polymerase, a primer, a fluorescent dye, and/or a metal-indicator dye. The sample analysis device 10 may mix the nucleic acid of the target pathogen extracted from the sample 111 with the materials necessary for the nucleic acid amplification after a temperature of the sample tray 11 is stabilized. The sample analysis device 10 may wait until the temperature of the sample tray 11 is stabilized.

In operation 550, the sample analysis device 10 may allow a first light source (e.g., the first light source 131 of FIG. 3) to emit first light (e.g., the first light 211 of FIG. 3). The sample analysis device 10 may irradiate the first light 211 to the sample 111.

In operation 570, the sample analysis device 10 may obtain third light (e.g., the third light 213 of FIG. 3) emitted after being excited by the first light 211 incident on the sample 111. For example, the sample analysis device 10 may allow a sensor (e.g., the sensor 135 of FIG. 3) to sense the third light 213 emitted after being excited by the first light 211 incident on the sample 111. The sample analysis device 10 may sense the third light 213 to measure fluorescence in real time.

Operations 510 to 570 may be performed sequentially, but embodiments are not limited thereto. For example, two or more operations may be performed in parallel.

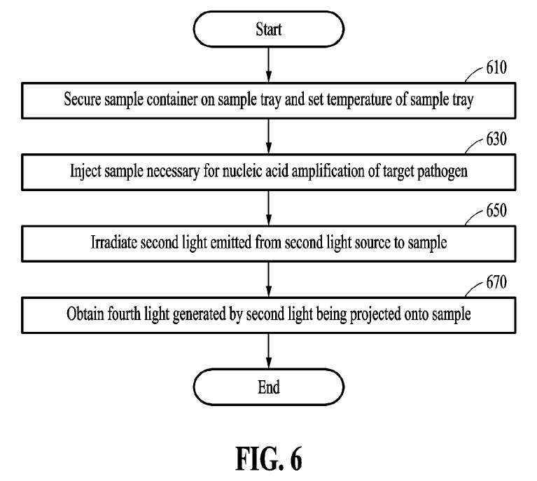

FIG. 6 is a flowchart illustrating an operation of sensing a change in color of a sample.

Referring to FIG. 6, operations 610 to 670 may be operations performed by a sample analysis device (e.g., the sample analysis device 10 of FIG. 1) described with reference to FIGS. 1 to 7.

In operation 610, the sample analysis device 10 may position and secure a sample container (e.g., the sample container 31 of FIG. 3) on a sample tray (e.g., the sample tray 11 of FIG. 1). The sample analysis device 10 may set a temperature of the sample tray 11 suitable for nucleic acid amplification of a target pathogen in the sample tray 11 through a temperature control unit (e.g., the temperature control unit 19 of FIG. 1).

In operation 630, the sample analysis device 10 may mix a nucleic acid of the target pathogen extracted from the sample (e.g., the sample 111 of FIG. 3) with materials necessary for the nucleic acid amplification. The sample analysis device 10 may inject mixed materials into the sample container 31. The materials necessary for the nucleic acid amplification may include a DNA polymerase, a primer, a fluorescent dye, and/or a metal-indicator dye. The sample analysis device 10 may mix the nucleic acid of the target pathogen extracted from the sample 111 with the materials necessary for the nucleic acid amplification after a temperature of the sample tray 11 is stabilized. The sample analysis device 10 may wait until the temperature of the sample tray 11 is stabilized.

In operation 650, the sample analysis device 10 may allow a second light source (e.g., the second light source 133 of FIG. 4) to emit second light (e.g., the second light 212 of FIG. 4). The sample analysis device 10 may irradiate the second light 212 to the sample 111.

In operation 670, the sample analysis device 10 may obtain fourth light (e.g., the fourth light 214 of FIG. 4) generated by the second light 212 being projected onto the sample 111. For example, the sample analysis device 10 may allow a sensor (e.g., the sensor 135 of FIG. 3) to sense the fourth light 214 generated by the second light 212 being projected onto the sample 111. The sample analysis device 10 may allow the sensor 135 to sense a disparity between the second light 212 and the fourth light 214. The sample analysis device 10 may allow the sensor 135 to sense a change in color of the sample 111 based on the disparity between the second light 212 and the fourth light 214. The change in color of the sample 111 may occur in one or more wavelength ranges within a visible light wavelength range. The change in color of the sample 111 may appear differently based on a degree of absorption of light of the sample 111.

Operations 610 to 670 may be performed sequentially, but embodiments are not limited thereto. For example, two or more operations may be performed in parallel.

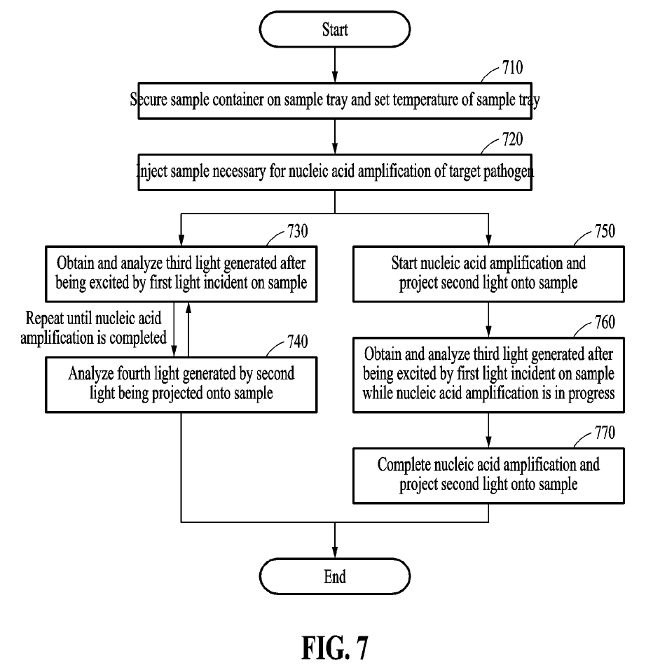

FIG. 7 is a flowchart illustrating an operation of sensing a fluorescent signal included in a sample or a change in color of the sample.

Referring to FIG. 7, operations 710 to 770 may be operations performed by a sample analysis device (e.g., the sample analysis device 10 of FIG. 1) described with reference to FIGS. 1 to 7.

In operation 710, the sample analysis device 10 may position and secure a sample container (e.g., the sample container 31 of FIG. 3) of a sample tray (e.g., the sample tray 11 of FIG. 1). The sample analysis device 10 may set a temperature of the sample tray 11 suitable for nucleic acid amplification of a target pathogen in the sample tray 11 through a temperature control unit (e.g., the temperature control unit 19 of FIG. 1).

In operation 720, the sample analysis device 10 may mix a nucleic acid of the target pathogen extracted from the sample (e.g., the sample 111 of FIG. 3) with materials necessary for the nucleic acid amplification. The sample analysis device 10 may inject mixed materials into the sample container 31. The materials necessary for the nucleic acid amplification may include a DNA polymerase, a primer, a fluorescent dye, and/or a metal-indicator dye. The sample analysis device 10 may mix the nucleic acid of the target pathogen extracted from the sample 111 with the materials necessary for the nucleic acid amplification after a temperature of the sample tray 11 is stabilized. The sample analysis device 10 may wait until the temperature of the sample tray 11 is stabilized.

In operation 730, the sample analysis device 10 may allow a first light source (e.g., the first light source 131 of FIG. 3) to emit first light (e.g., the first light 211 of FIG. 3). The sample analysis device 10 may irradiate the first light 211 to the sample 111. The sample analysis device 10 may obtain third light (e.g., the third light 213 of FIG. 3) emitted after being excited by the first light 211 incident on the sample 111. For example, the sample analysis device 10 may allow a sensor (e.g., the sensor 135 of FIG. 3) to sense the third light 213 emitted after being excited by the first light 211 incident on the sample 111. The sample analysis device 10 may sense the third light 213 to measure fluorescence in real time. The sample analysis device 10 may allow a processing unit (e.g., the processing unit 15 of FIG. 1) to analyze the third light 213.

In operation 740, the sample analysis device 10 may allow a second light source (e.g., the second light source 133 of FIG. 4) to emit second light (e.g., the second light 212 of FIG. 4). The sample analysis device 10 may irradiate the second light 212 to the sample 111. The sample analysis device 10 may obtain fourth light (e.g., the fourth light 214 of FIG. 4) generated by the second light 212 being projected onto the sample 111. For example, the sample analysis device 10 may allow a sensor (e.g., the sensor 135 of FIG. 3) to sense the fourth light 214 generated by the second light 212 being projected onto the sample 111. The sample analysis device 10 may allow the sensor 135 to sense a disparity between the second light 212 and the fourth light 214. The sample analysis device 10 may allow the sensor 135 to sense a change in color of the sample 111 based on the disparity between the second light 212 and the fourth light 214. The sample analysis device 10 may allow the processing unit 15 to analyze the disparity between the second light 212 and the fourth light 214. The sample analysis device 10 may repeat operations 730 and 740 until the nucleic acid amplification is completed.

In operation 750, the sample analysis device 10 may amplify the nucleic acid and may allow the second light source 133 to emit the second light 212. The sample analysis device 10 may allow the sensor 135 to sense the fourth light 214 generated by the second light 212 being projected onto the sample 111.

In operation 760, the sample analysis device 10 may allow the sensor 135 to sense the third light 213, which may be fluorescence emitted after being excited by the first light 211 incident on the sample 111, while the nucleic acid amplification is in progress. The sample analysis device 10 may allow the processing unit 15 to analyze the third light 213.

In operation 770, after the nucleic acid amplification is completed, the sample analysis device 10 may allow the second light source 133 to emit the second light 212 again. The sample analysis device 10 may allow the sensor 135 to sense the fourth light 214 generated by the second light 212 being projected onto the sample 111. The sample analysis device 10 may, after the nucleic acid amplification is completed, allow the sensor 135 to sense a change in color of the sample 111 based on the disparity between the second light 212 and the fourth light 214 of operation 750.

Operations 710 to 770 may be performed sequentially, but embodiments are not limited thereto. For example, two or more operations may be performed in parallel.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and software applications that run on the OS. The processing device also may access, store, manipulate, process, and generate data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, different processing configurations are possible, such as one including parallel processors.

The software may include a computer program, a piece of code, instructions, or some combination thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The non-transitory computer-readable media may also store the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, one of ordinary skill in the art may apply various technical modifications and variations based thereon. For example, suitable results may be achieved if the described techniques are performed in a different order and/or if components in a described system, architecture, device, or circuit are combined in a different manner, or replaced or substituted by other components or their equivalents.

Therefore, other implementations, other embodiments, and equivalents to the claims are also within the scope of the following claims.

What is claimed is:

1. A sample analysis device comprising:
a sample tray on which a sample is placed;
a measurement unit configured to measure the sample based on light emitted from the sample or transmitted through the sample; and
a processing unit configured to analyze the sample based on the light,
wherein the measurement unit comprises:
a first light source configured to emit first light;
a second light source configured to emit second light; and
a sensor configured to sense third light and fourth light, wherein the third light is fluorescence emitted after being excited by the first light incident on the sample, and wherein the fourth light is generated by the second light being transmitted through the sample, and
wherein the light comprises the third light and the fourth light obtained from the sensor.

2. The sample analysis device of claim 1, wherein the measurement unit further comprises:
a mirror disposed in a path of the first light to reflect the first light and irradiate the first light to the sample.

3. The sample analysis device of claim 2, wherein
the mirror is a dichroic mirror that reflects light of a specific wavelength.

4. The sample analysis device of claim 1, wherein
the processing unit is configured to analyze the sample based on a disparity between the second light and the fourth light, and the third light.

5. The sample analysis device of claim 1 further comprising:
a temperature control unit configured to control a temperature of the sample tray.

6. The sample analysis device of claim 1, wherein
the first light source and the second light source are configured to simultaneously emit the first light and the second light, respectively.

7. The sample analysis device of claim 1, wherein
the second light source is a multi-wavelength light source, and
the second light has a uniform intensity of light in each wavelength range.

8. The sample analysis device of claim 1, further comprising:
a display configured to display a result of analyzing the sample, obtained from the processing unit.

9. The sample analysis device of claim 4, wherein the processing unit is configured to:
synchronize a first signal with a second signal, wherein the first signal is generated based on a disparity between the second light and the fourth light, and wherein the second signal is based on the third light.

10. A method of analyzing a sample, performed by a sample analysis device, the method comprising:
emitting each of first light and second light;
sensing third light and fourth light, wherein the third light is fluorescence emitted after being excited by the first light incident on the sample placed on a sample tray, and wherein the fourth light is generated by the second light being transmitted through the sample; and
analyzing the sample based on the third light and the fourth light.

11. The method of claim 10, wherein the emitting of each of the first light and the second light comprises:
emitting the first light using a first light source; and
emitting the second light using a second light source.

12. The method of claim 10, wherein the analyzing of the sample comprises:
analyzing the sample based on a disparity between the second light and the fourth light, and the third light.

13. The method of claim 11, wherein
the first light source and the second light source are configured to simultaneously emit the first light and the second light, respectively.

14. The method of claim 11, wherein
the second light source is a multi-wavelength light source, and
the second light has a uniform intensity of light in each wavelength range.

15. The method of claim 10, wherein the sensing of the third light and the fourth light comprises:
irradiating the first light, which is reflected by a mirror disposed in a path of the first light, to the sample.

16. The method of claim 15, wherein
the mirror is a dichroic mirror that reflects light of a specific wavelength.

17. The method of claim 10, further comprising:
displaying a result of analyzing the sample.

18. The method of claim 12, wherein the analyzing of the sample comprises:
synchronizing a first signal with a second signal, wherein the first signal is generated based on a disparity between the second light and the fourth light, and wherein the second signal is based on the third light; and
analyzing the sample based on the first signal and the second signal.
